(19) United States
(12) Patent Application Publication
(10) Pub. No.: US 2026/0200164 A1
(43) Pub. Date: Jul. 16, 2026

(54) ULTRATHIN BLOWN FILM WITH SPECIFIC PROPERTIES

(71) Applicant: Covestro Deutschland AG, Leverkusen (DE)

(72) Inventors: Christian Windeck, Viersen (DE); Juergen Flecke, Dormagen (DE); Marieelen Oelkers, Gerdau (DE); Theivanayagam Deivaraj, Düsseldorf (DE); Helge Kosthorst, Visselhövede (DE)

(21) Appl. No.: 19/132,523

(22) PCT Filed: Dec. 1, 2023
(86) PCT No.: PCT/EP2023/084016

§ 371 Date: May 23, 2025

(30) Foreign Application Priority Data
Dec. 5, 2022 (EP) 22211503.2

(51) Int. Cl. B29C 49/04; B29C 49/64; B29K 33/00; B29K 67/00; B29K 69/00; B29K 105/00

(52) U.S. Cl. CPC B29C 49/04112; B29C 49/04116; B29C 49/6464; B29C 49/6465; B29K 2033/12; B29K 2067/00; B29K 2069/00; B29K 2105/0088; B29K 2105/251

(57) ABSTRACT

The invention is related to a layered structure S., also called film, comprising at least one first layer A. with a first surface A1 and a second surface A2, comprising at least polymer (A), wherein the first layer A. has a thickness in a range of 3 to 50 μm, preferably in a range of 4 to 30 μm, most preferably in a range of from 5 to 20 μm, and optionally at least one further layer B, wherein the layered structure S. is obtained in a blown film process and wherein polymer (A) is selected from the group consisting of a polycarbonate, a co-polycarbonate, a blend comprising a polycarbonate or a co-polycarbonate, a poly(methyl)methacrylate, a polyester, a co-polyester or a mixture or combination of at least two thereof as well as a process for its production as well as the use as coating for interior and exterior applications, as membrane or other applications with special properties low birefringence of at least layer A. and no chattermarks.

The invention is related to a layered structure S., also called film, comprising at least one first layer A. with a first surface A1 and a second surface A2, comprising at least polymer (A), wherein the first layer A. has a thickness in a range of 3 to 50 μm, preferably in a range of 4 to 30 μm, most preferably in a range of from 5 to 20 μm, and optionally at least one further layer B, wherein the layered structure S. is obtained in a blown film process and wherein polymer (A) is selected from the group consisting of a polycarbonate, a co-polycarbonate, a blend comprising a polycarbonate or a co-polycarbonate, a poly(methyl)methacrylate, a polyester, a co-polyester or a mixture or combination of at least two thereof as well as a process for its production as well as the use as coating for interior and exterior applications, as membrane or other applications like battery or as part for optical applications.

The production of very thin layers has limits because a lot of parameters have to be controlled during production, transportation and use of the thin layer. So far it is not easy to produce thin films with continuous good quality in a broad manner for various applications, especially in blown film production. The material has to have specific properties in the melt phase but also after cooling of the melt when collapsing (lay-flat) at the haul-off of a blown film line. A sufficiently high melt strength of the material is needed for bubble stability in a blown film process. Simultaneously, the blown film has to be collapsed and redirected easily by rolls when cooled down without creating cracks or waves. Up to now, materials like polycarbonate have been excluded from processing in blown film production as it is not easy to create a good quality film. The rigidity of the material leads to cracks and waves in the film.

Therefore, it exists a need to diminish at least one of the aforementioned problems. Especially, there is a need for develop a layered structure that incorporates at least one thin layer or thin film comprising stiff material produced in a blown film process. Further, it exists a need to develop a layered structure that incorporates at least one thin layer comprising chemically resistant materials with a high quality standard especially with respect to a constant thickness and/or low birefringence and/or no chattermarks which can be used for different applications like interior as well as exterior applications, membranes and others like battery or as part for optical applications, especially optical applications. Furthermore, there is a need for an adapted blown film process to develop a layered structure that incorporates at least one thin layer or thin film comprising stiff material with the properties described above, especially for optical applications.

A solution for such a layered structure is described in claim 1 and its dependent claims in correlation to a layered structure S.

A first aspect of the invention refers to a layered structure S., comprising:
A. at least one first layer A., with a first surface A1 and a second surface A2, comprising at least polymer (A), wherein the first layer A. has a thickness in a range of 3 to 50 μm, preferably in a range of 4 to 30 μm, most preferably in a range of from 5 to 20 μm, and
B. optionally at least one further layer B. comprising at least polymer (B),
wherein the layered structure S. is obtained in a blown film process and wherein polymer (A) is selected from the group consisting of a polycarbonate, a co-polycarbonate, a blend comprising a polycarbonate (PC) or a co-polycarbonate (co-PC), a poly(methyl)methacrylate (PMMA), a polyester (PET), a co-polyester (co-PET) or a mixture or combination of at least two thereof.

Preferably, the at least one first layer A. comprises a solvent in an amount of from 0.001 to 0.5 wt.-%, based on the total weight of layer A. As solvent every fluid material should be covered that is able to solve at least one ingredient incorporated in the first layer A. Examples of solvents are molecules with a molecular weight≤1 000 g/mol, preferably of ≤500 g/mol, more preferably of ≤ 400 g/mol. like water, alcohols, ethers, esters, ketones, aldehydes or mixtures of at least two thereof.

Further preferably, the at least one first layer A. comprises polymer (A) in an amount in a range of from 50 to 100 wt.-%; preferably in a range of from 70 to 99 wt.-%, more preferably in a range of from 80 to 97 wt.-%, most preferably in a range of from 90 to 95 wt.-%, based on the total weight of the first layer A. Layer A. may comprise at least one further additive. As additive every component is understood which does not belong to the group of solvents, but also has a molecular weight below ≤1 000 g/mol, more preferably of ≤500 g/mol, even more preferably of ≤400 g/mol. The further additive is preferably selected from the group consisting of pigments, dyes, surfactants, waxes, a UV absorber and a colorant or mixtures of at least two thereof. Preferably, layer A. comprises the additive or the sum of all additives in an amount in a range of from 0 to 10 wt.-%, more preferably in an range of from 0.1 to 7 wt.-%, most preferably in an range of from 0.5 to 5 wt.-%, based on the total weight of layer A . . .

Preferably, the polymer (A) selected from the group consisting of a polycarbonate, a co-polycarbonate, a blend comprising a polycarbonate or a co-polycarbonate, a poly(methyl)methacrylate, a polyester, a co-polyester, especially preferably a polycarbonate, a co-polycarbonate, a blend comprising a polycarbonate or a co-polycarbonate, a poly(methyl)methacrylate or a mixture of at least two thereof. Preferably, layer A. comprises polymer (A), especially a polycarbonate, a co-polycarbonate, a blend comprising a polycarbonate or a co-polycarbonate, a poly(methyl)methacrylate or a mixture of at least two thereof, in an amount in a range of from 50 to 100 wt.-%; preferably in a range of from 70 to 99 wt.-%, more preferably in a range of from 80 to 97 wt.-%, most preferably in a range of from 90 to 95 wt.-%, based on the total weight of the first layer A.

Preferably, layer A. comprises more than one sheet of polymer (A), more preferably in a range of 2 to 4 sheets. Preferably, the sheets of polymer (A) have a thickness in the range of 3 to 20 μm, more preferably in a range of 4 to 15 μm, most preferably in a range of 5 to 10 μm and comprise the same polymers (A).

Furthermore, the layered structure S. may comprise more than one first layer A. The difference between more than one sheet of polymer (A) and more than one first layer A. is the fact that the different sheets all comprise the same composition, whereas the different first layers A. either comprise different compositions, like different polymers (A) or are positioned between two or more different further layers B. and/or C.

Preferably, the polymer (A) provides a glass-transition temperature Tg in a range of from ≥70° C.; preferably in a range of from 80 to 250° C., more preferably in a range of from 80 to 240° C.; most preferably in a range of from 80 to 200° C., determined via differential scanning calorimetry (DSC) according to standard DIN EN 61006:2004 at a heating-rate of 20 K/min with definition of Tg as the midpoint temperature (tangent method).

Preferably, the at least one first layer A. has a hardness≥85 D, measured according to DIN EN ISO 868-2003-10.

Particularly preferred polymers (A) are one or more polycarbonate(s) or copolycarbonate(s) based on diphenols or blends comprising at least one polycarbonate or copolycarbonate. Very particular preference is given to blends containing at least one polycarbonate or copolycarbonate and at least one poly- or copolycondensate of terephthalic acid, of naphthalenedicarboxylic acid or of a cycloalkyldicarboxylic acid, preferably of cyclohexanedicarboxylic acid. Very particular preference is given to polycarbonates or copolycarbonates, especially having average molecular weights Mw of 500 to 100 000 g/mol, preferably of 10 000 to 80 000 g/mol, particularly preferably of 15 000 to 40 000 g/mol, or blends thereof with at least one poly- or copolycondensate of terephthalic acid having average molecular weights Mw of 10 000 to 200 000 g/mol, preferably of 21 000 to 120 000 g/mol.

All mentioned molecular weight values are number average molecular weight if not noted differently. The number average molecular weight is determined within the scope of this application by gel permeation chromatography (GPC) in tetrahydrofuran at 23° C., unless otherwise described. The procedure is carried out according to DIN 55672-1: “Gel permeation chromatography, Part 1-Tetrahydrofuran as eluent” (SECurity GPC system from PSS Polymer Service, flow rate 1.0 ml/min; columns: 2×PSS SDV linear M, 8×300 mm, 5 μm; RID detector). Polystyrene samples of known molecular weight are used for calibration. The calculation of the number-average molecular weight is software-supported. Baseline points and evaluation limits are defined in accordance with DIN 55672 Part 1.

Suitable poly- or copolycondensates of terephthalic acid in preferred embodiments of the invention are polyalkylene terephthalates. Suitable polyalkylene terephthalates are for example reaction products of aromatic dicarboxylic acids or their reactive derivatives (for example dimethyl esters or anhydrides) and aliphatic, cycloaliphatic or araliphatic diols and mixtures of these reaction products.

Preferred polyalkylene terephthalates may be prepared from terephthalic acid (or reactive derivatives thereof) and aliphatic or cycloaliphatic diols having 2 to 10 C atoms by known methods (Kunststoff-Handbuch, vol. VIII, p. 695 ff, Carl-Hanser-Verlag, Munich 1973).

Preferred polyalkylene terephthalates contain at least 80 mol %, preferably 90 mol %, of terephthalic acid radicals, based on the dicarboxylic acid component, and at least 80 mol %, preferably at least 90 mol %, of ethylene glycol and/or butane-1,4-diol and/or cyclohexane-1,4-dimethanol radicals based on the diol component.

The preferred polyalkylene terephthalates may contain, in addition to terephthalic acid radicals, up to 20 mol % of radicals of other aromatic dicarboxylic acids having 8 to 14 carbon atoms or of aliphatic dicarboxylic acids having 4 to 12 carbon atoms, such as for example radicals of phthalic acid, isophthalic acid, naphthalene-2,6-dicarboxylic acid, 4,4′-diphenyldicarboxylic acid, succinic acid, adipic acid, sebacic acid, azelaic acid, cyclohexanediacetic acid.

The preferred polyalkylene terephthalates may contain, in addition to ethylene and/or butane-1,4-diol glycol radicals, up to 80 mol % of other aliphatic diols having 3 to 12 carbon atoms or of cycloaliphatic diols having 6 to 21 carbon atoms, for example radicals of propane-1,3-diol, 2-ethylpropane-1,3-diol, neopentyl glycol, pentane-1,5-diol, hexane-1,6-diol, cyclohexane-1,4-dimethanol, 3-methylpentane-2,4-diol, 2-methylpentane-2,4-diol, 2,2,4-trimethylpentane-1,3-diol and 2-ethylhexane-1,6-diol, 2,2-diethylpropane-1,3-diol, hexane-2,5-diol, 1,4-di([beta]-hydroxyethoxy)benzene, 2,2-bis(4-hydroxycyclohexyl) propane, 2,4-dihydroxy-1,1,3,3-tetramethylcyclobutane, 2,2-bis(3-[beta]-hydroxyethoxyphenyl)propane and 2,2-bis(4-hydroxypropoxyphenyl) propane (cf. DE-OS 24 07 674, 24 07 776, 27 15 932).

The polyalkylene terephthalates may be branched by incorporation of relatively small amounts of tri- or tetrahydric alcohols or tri- or tetrabasic carboxylic acids, as described for example in DE-OS 19 00 270 and US-PS 3 692 744. Examples of preferred branching agents are trimesic acid, trimellitic acid, trimethylolethane and trimethylolpropane and pentaerythritol.

Preferably, the layered structure S., the layered structure S. comprises at least one further layer B. comprising at least one polymer (B). Polymer (B) could be any polymer that the person skilled in the art would select as stabilizing or carrier material for layer A. in a blown film process. Preferably, polymer (B) provides a high melt strength when used in a blown film process to form layer B. Preferably, layer B. comprises more than one sheet of polymer (B), more preferably in a range of 2 to 4 sheets. Preferably, the sheets of polymer (B) have a thickness in the range of 5 to 100 μm, more preferably in a range of 7 to 50 μm, most preferably in a range of 10 to 20 μm.

Polymer (B) can be any polymer the person skilled in the art would select for the establishment of layer B. in a layered structure S. Preferably, the polymer (B) provides a Tg in a range of from −130 to 50° C., more preferably in a range of from −100 to 10° C., determined via differential scanning calorimetry (DSC) according to standard DIN EN 61006:2004 at a heating-rate of 20 K/min with definition of Tg as the midpoint temperature (tangent method).

Particularly suitable polymers (B) are polyolefin(s) such as, by way of example and preferably, polypropylene (PP), polyethylene (PE) types or cyclic olefins (COC) e.g. TOPAS® of Hoechst (now TOPAS Advanced Polymers), mixtures of at least two of the aforementioned or blends thereof, especially preferably polypropylene, polyethylene types.

Preferably, further layer B. comprises polymer (B) in an amount in a range of from 50 to 100 wt.-%, preferably in a range of from 70 to 99 wt.-%, more preferably in a range of from 80 to 97 wt.-%, most preferably in a range of from 90 to 95 wt.-%. Layer B. may comprise at least one further additive. The additive is preferably selected from the group consisting of pigments, dyes, surfactants, a UV absorber and a colorant or mixtures of at least two thereof. Preferably, layer B. comprises the additive or the sum of all additives in an amount in a range of from 0.1 to 10 wt.-%, more preferably in an range of from 0.2 to 7 wt.-%, most preferably in an range of from 0.5 to 5 wt.-%, based on the total weight of layer B.

In a preferred embodiment of the layered structure S. the layered structure S. comprises at least one further layer B., wherein the polymer (B) is selected from the group consisting of a cyclo olefin copolymer (COC), a polyolefine or a mixture or blend of at least two thereof.

In a preferred embodiment of the layered structure S., layer A. comprises the polymer (A) in an amount in a range of from 50 to 100 wt.-%; preferably in a range of from 70 to 99 wt.-%, more preferably in a range of from 80 to 97 wt.-%, most preferably in a range of from 90 to 95 wt.-%, based on the total weight of the at least one layer A.

In a preferred embodiment of the layered structure S., layer B. comprises the polymer (B) in an amount in a range of from 50 to 100 wt.-%, preferably in a range of from 70 to 99 wt.-%, more preferably in a range of from 80 to 97 wt.-%, most preferably in a range of from 90 to 95 wt.-%, based on the total weight of layer B.

Preferably, the layered structure S. comprises a first layer A. and a second layer B, wherein the first layer A. of the layered structure S. comprises at least one polymer (A) providing a Tg in a range of from 80 to 250° C., more preferably in a range of from 80 to 240° C.; most preferably in a range of from 80 to 200° C., and the second layer B. comprises at least one polymer (B) providing a Tg in a range of from −130 to 50° C., more preferably in a range of from −100 to 10° C., wherein Tg is determined via differential scanning calorimetry (DSC) according to standard DIN EN 61006:2004 at a heating-rate of 20 K/min with definition of Tg as the midpoint temperature (tangent method).

In a preferred embodiment of the layered structure S., layer A. of the layered structure S. provides at least one, preferably two, more preferably all of the following properties:
S1. in case layer B. is present, an adhesion force between the at least one first layer A. and the at least one further layer B. is in a range of from 0.001 to 0.1 N/cm, preferably from 0.005 to 0.05 N/cm, most preferably from 0.007 to 0.03 N/cm, measured according to ASTM D903-1998 at a pulling angle of 180°;
S2. a melting temperature of polymer (A)≥150° C.; preferably in a range of from 160 to 300° C., more preferably in a range of from 200 to 280° C.; most preferably in a range of from 220 to 250° C., determined via differential scanning calorimetry (DSC) according to standard DIN EN 61006:2004 at a heating-rate of 20 K/min with definition of Tg as the midpoint temperature (tangent method)
S3. a glass-transition temperature Tg of polymer (A) of ≥40° C.; preferably in a range of from 50 to 250° C., more preferably in a range of from 130 to 240° C.; most preferably in a range of from 140 to 200° C., determined via differential scanning calorimetry (DSC) according to standard DIN EN 61006:2004 at a heating-rate of 20 K/min with definition of Tg as the midpoint temperature (tangent method) or a vicat softening temperature B/50 determined according to ISO 306 (50N; 50°/h) of ≥70° C.; preferably in a range of from 75 to 230° C., more preferably in a range of from 80 to 230° C.; most preferably in a range of from 85 to 225° C.;
S4. Melt volume rate (MVR; measured according to DIN ISO1133-1-2012-03; 300° C., 2.16 kg) of ≥3 cm³/10 min, more preferably of ≥3.5 cm³/10 min, even more preferably of ≥4 cm³/10 min;
S5. solvents in a range of from 0 to 0.5 wt.-%, preferably 0.01 to 0.3 wt.-%.

Preferably, the layered structure S. provides one property or one property combination selected from the group consisting of S1.; S2.; S3.; S4.; S5.; S1, and S2.; S1, and S3.; S1, and S4.; S1, and S5.; S2. and S3.; S2, and S4.; S2, and S5.; S3, and S4.; S3, and S5.; S4, and S5.; S1, and S2, and S3.; S1. and S2, and S4.; S1, and S2, and S5.; S1, and S3, and S4.; S1, and S3, and S5.; S1, and S4, and S5.; S2. and S3, and S4.; S2, and S3, and S5.; S2, and S4, and S5.; S3, and S4, and S5.; S1, and S2, and S3. and S4.; S1, and S2, and S3, and S5.; S1, and S2, and S4, and S5.; S1, and S3, and S4, and S5.; S2. and S3, and S4, and S5.; S1, and S2, and S3, and S4, and S5 . . . . Most preferably, the layered structure S. provides property S1.

It is especially preferred that the adhesion force between the at least one first layer A. and the at least one further layer B. is in a range of from 0.001 to 0.1 N/cm, preferably from 0.005 to 0.05 N/cm, most preferably from 0.007 to 0.03 N/cm, measured according to ASTM D903-1998 at a pulling angle of 180°.

In a preferred embodiment of the layered structure S. the layered structure S. provides at least one, preferably two, more preferably all of the following properties:
S6. a thickness in a range of from 15 to 250 μm, preferable in a range of from 20 to 200 μm, and most preferably in a range of from 30 to 100 μm;
S7. a deviation of the thickness across an area of 20*20 cm² in a range of from 0.1 to 3 μm, preferably of from 0.15 to 2 μm, more preferably of from 0.2 to 1 μm;
S8. a tensile strength in a range of from 10 to 150 MPa, preferably of from 20 to 100 MPa, measured according to DIN EN ISO 527-1:2012-06;
S9. an elongation at break in a range of from 20 bis 500%, preferably of from 50 to 400%, measured according to DIN N ISO 527-1:2012-06;
S10. water absorption (ISO 62:2008; at 23° C. for 24 h) in a range of from 0.01 to 0.5 wt.-%, more preferably) in a range of from 0.05 to 0.4 wt.-% (saturation value).

Preferably, the layered structure S. provides one property or one property combination selected from the group consisting of S6., S7.; S8.; S9.; S10.; S6, and S7.; S6, and S8.; S6, and S9.; S6, and S10.; S7, and S8.; S7, and S9.; S7, and S10.; S8, and S9.; S8, and S10.; S8, and S11.; S9, and S10.; S6. and S7, and S8.; S6, and S7, and S9.; S6, and S7, and S10.; S6, and S8, and S9.; S6, and S8. and S10.; S6, and S9, and S10.; S7, and S8, and S9.; S7, and S8, and S10.; S7, and S9, and S10.; S8. and S9, and S10.; S6, and S7, and S8, and S9.; S6, and S7, and S9, and S10.; S6, and S8, and S9. and S10.; S7, and S8, and S9, and S10.; S6, and S7, and S8, and S9, and S10.

Preferably, the layered structure S. provides in addition to any of properties S1. to S5 and their mentioned combinations any combination of properties listed for S6. to S10. above.

Preferably, the adhesion force between layer A. and layer B. is selected in a range where the two layers A. and B. could be separated easily by manual force but do not fall apart on their own without input of any force. The adhesion between the layers A. and B. allow a transportation of the layered structure S. without the risk of cracks in the thin layer A., but make it easy to provide layer A. for further processing by just separating layer B. by hand or a machine using small forces. The separation of layer A. from layer B. is preferably provided without any detectable residues of polymer (B) on layer A.

Preferably, the adjustment of the adhesion between layer A. and layer B. is not supported by any additives in or between layer A. and layer B. As the layered structure S. may be used in specific applications where no additives are desired, the content of additives like plasticizers, deformers, pigments and any other organic or inorganic components are preferably low.

In a preferred embodiment of the layered structure S., layer A. provides at least one, preferably at least two, more preferably at least three, even more preferably at least four, most preferably all of the following properties:
a1. a gloss at 60° angle in a range of 10 to 110, measured according to DIN EN ISO 2813-2015-02;
a2. a surface roughness of at least the first surface A1 in a range of 0.1 to 5.50 μm, measured according to DIN EN ISO 4287:2010-07/DIN EN ISO 4288:1998-04;
a3. a birefringence in a range of from 1 to 100 nm, preferably, in a range of 1 to 20 nm, measured by a polarization microscope;
a4. a transparency in a range of from 5 to 95%, measured according to ASTM D1003-13;
a5. no optical deviations like chattermarks.

Preferably, the layer A. provides one property or one property combination selected from the group consisting of a1.; a2.; a3.; a4.; a5.; a1, and a2.; a1, and a3.; a1, and a4.; a1, and a5.; a2, and a3.; a2. and a4.; a2, and a5.; a3, and a4.; a3, and a5.; a4, and a5.; a1, and a2, and a3.; a1, and a2, and a4.; a1. and a2, and a5.; a1, and a3, and a4.; a1, and a3, and a5.; a1, and a4, and a5.; a2, and a3, and a4.; a2. and a3, and a5.; a2, and a4, and a5.; a3, and a4, and a5.; a1, and a2, and a3, and a4.; a1, and a2. and a3, and a5.; a1, and a2, and a4, and a5.; a1, and a3, and a4, and a5.; a2, and a3, and a4, and a5.; a1. and a2, and a3, and a4, and a5.; More preferably, the layer A. provides property a3. Most preferably, the layer A. provides property a3, and a5.

In a preferred embodiment of the layered structure S., layer A. provides at least one, preferably at least two, more preferably at least three, even more preferably at least four, most preferably all of the following properties:
a6. a density in a range of from 1 to 1.35 g/l, measured according to ISO 1183-1:2019-09;
a7. a tensile strength in a range of from 10 to 150 MPa, preferably of from 20 to 100 MPa, measured according to DIN EN ISO 527-1:2012-06;
a8. an elongation at break in a range of from 20 bis 500%, preferably of from 50 to 400%, measured according to DIN N ISO 527-1:2012-06;
a9. a thickness in a range of from 3 to 50 μm, preferable in a range of from 4 to 30 μm, and most preferably in a range of from 5 to 20 μm;
a10. a deviation of the thickness in a range of from 0.1 to 3 μm, preferably of from 0.15 to 2 μm, most preferably of from 0.2 to 1 μm.

In a preferred embodiment of the layered structure S. the layered structure S. further comprises at least one layer C., comprising a polymer (C).

Polymer (C) can be any polymer the person skilled in the art would select for the establishment of layer C. in a layered structure S. in a blown film process.

Preferably, polymer (C) is selected from the list of polymers mentioned for polymer (B).

In a preferred embodiment of the layered structure S. polymer (C) is different from polymer (A) and/or polymer (B). Preferably, polymer (C) is different from polymer (A). Preferably, polymer (C) is a polyolefine.

Layer C. may comprise at least one further additive. The additive is preferably selected from the group consisting of pigments, dyes, surfactants, deformers, plasticizers, a UV absorber and a colorant or mixtures of at least two thereof. Preferably, layer C. comprises the additive or the additives in a total amount in a range of from 0.01 to 0.5 wt.-%, more preferably in an range of from 0.05 to 0.4 wt.-%, most preferably in an range of from 0.1 to 0.3 wt.-%, based on the total weight of layer C.

In a preferred embodiment of the layered structure S. the at least first layer A. is positioned between two layers B. Preferably at least one layer C. is positioned on top of each layer A. In an alternative preferred embodiment of the layered structure S. the at least one layer A. is positioned between at least one further layer B. and at least one layer C.

Preferably, the layered structure S. is assembled in a layer combination selected from the group consisting of:
(layer A.-layer B.)ᵢ with i=1 to 5, preferably 1 to 3;
layer B.-(layer A.-layer B.)ᵢ with i=1 to 5, preferably 1 to 3;
layer B.-(layer A.-layer C.)ᵢ with i=1 to 5, preferably 1 to 3, optionally-layer A., optionally layer B.;
In a preferred embodiment of the layered structure S. the at least first layer A. is positioned between two further layers B., preferably in form layer B.-(layer A.-layer B.)ᵢ with i=1 to 5.

A further aspect of the invention is related to a process for the manufacture of a layered structure S., wherein the layered structure S. comprises at least one first layer A. having a thickness in a range of from 3 to 50 μm, preferably from 4 to 30 μm, more preferably from 5 to 20 μm comprising at least the following steps
P1. providing a granulate A. comprising a polymer (A),
P2. providing a granulate B. comprising a polymer (B),
P3. optionally, providing a granulate C. comprising a polymer (C),
P4. heating granulate A. and granulate B. and/or optionally granulate C. to a temperature T which is at least 50° C., preferably at least 100° C., higher than the softening point or the glass transition temperature of the respective polymer (A), (B) and/or optionally (C) to receive the melts (A), (B) and optionally (C);
P5. extruding the melt of at least melt (A) and melt (B) and/or optionally melt (C) in a blown film extrusion line to receive an extrudate of at least one layer A. from melt (A) with a thickness in a range of from 3 to 50 μm and at least one further layer B. from melt (B) and/or optionally at least one layer C. from melt (C) to receive the layered structure S.;
P6. cooling down the layered structure S. to a temperature in a range of from 10 to 50° C.;
P7. optionally winding the layered structure S. onto a roll;
P8. optionally post processing the layered structure S., whereby the post processing is preferably selected from the group consisting of printing onto at least one surface, forming, laser marking or a combination of at least two thereof;
P9. optionally delaminating layers A., B. or C. through an unwinding and rewinding process, or preferably inline during extrusion processing
wherein polymer (A) is selected from the group consisting of a polycarbonate, a co-polycarbonate, a blend comprising a polycarbonate or a co-polycarbonate, a poly(methyl)methacrylate, a polyester, a co-polyester or a mixture or combination of at least two thereof.

Providing in step P1. of granulate A. comprising a polymer (A) can be established by any means the person skilled in the art would select for a blown film extrusion process.

Providing in step P2. of granulate B. comprising a polymer (B) can be established by any means the person skilled in the art would select for the process. Providing in step P2. of granulate C. comprising a polymer (C) can be established by any means the person skilled in the art would select for the process. Preferably, providing in step P1, or step P2, or step P3. are established by using an extruder.

In the blown film extrusion process, the granulate(s) of the different polymers are conveyed from dryers into filling hoppers of the respective extruder via dosing systems. The material is molten and conveyed in the barrel/screw plasticizing system of the extruder (1) as shown in FIG. 5. Optionally, a melt pump for regulation of the pressure in the extruder for constant material delivery could be added in front of the die inlet. Each melt may pass a screen changer with filter elements and enters the blown film die, preferably a die head (2), via individual melt pipes.

The heating of polymer (A) in form of granulate A. and polymer (B) in form of granulate B. and optionally polymer (C) in from of granulate C. in step P4. to a temperature T which is at least 50° C. higher than the softening point or the glass transition temperature of the respective polymer (A), (B) and optionally (C) to receive the melts (A), (B) and optionally (C) could be established by any means selected by the person skilled in the art. If an extruder is utilized in steps P1. to P3. the extruder includes means for heating.

Combining the melts of at least melt (A) and melt (B) and optionally melt (C) in step P5. is established in a blown film die (die head) to receive at least one layer A. from melt (A) with a thickness in a range of from 3 to 50 μm and a layer B. from melt (B) and optionally at least one layer C. from melt (C) to receive the layered structure S. can be performed by any means the person skilled in the art would select for combining melts. Preferably, the melts (A) and (B) and optionally (C) are combined in a die head for blown film production processes. In the die head, usually spiral mandrels shape each material in an annular ring and the layers join together before the exit of the die head and a co-extrudate is received.

Preferably, the layered structure S. comprises a layer sequence selected from the group consisting of (layer A.-layer B.); with i=1 to 5, preferably 1 to 3; layer B.-(layer A.-layer B.); with i=1 to 5, preferably 1 to 3; layer B.-(layer A.-layer C.); with i=1 to 5, preferably 1 to 3, optionally-layer A., optionally layer B.

The co-extrudate exiting the die head is shaped to a so called bubble (3) as shown in FIG. 5. The bubble is blown up by air which induces a radial stretching of the film. The film is air cooled by internal bubble cooling (4), which may have a pressure control and air exchange, and external cooling ring (5). The dimensionless blow-up-ratio (BUR) is a characteristic measure for the radial stretching in blown film extrusion, describing the bubble diameter vs. the diameter of the film at the die exit.

Cooling down the layered structure S. in step P6. to a temperature in a range of from 20 to 80° C. could be established by any means the person skilled in the art would select for cooling layers. Preferably, cooling is established by leading the layered structure S. up along a path of at least 5 meters, preferably in a range of 5 to 50 meters, more preferably of 10 to 20 meters at room temperature, preferably in a temperature range of 20 to 50° C., more preferably in a range of 25 to 40° C. If cooling shall be accelerated, a cooling medium, like a cool fluid in form of cool air may be directed onto the layer. The cool fluid in form of air preferably has a temperature in a range of rom 1° C. to 50° C.

Furthermore, the bubble is hauled-off horizontally by a haul-off unit (6) as shown in FIG. 5, which induces an axial stretching of the film. The dimensionless Take-up-ratio (TUR) is a characteristic measure for the axial stretching in blown film extrusion, describing the ratio of film line speed divided by the average die head outflow velocity of the co-extrudate.

Finally, the film is collapsed by a collapsing frame before guided into slitting (7) and winding stations (8) as shown in FIG. 5. Winding up the layered structure S. onto a roll in step P7. may be established by any means the person skilled in the art would select for rolling layers. Preferably, the rolling up is established by a conventional roll winder.

Post processing the layered structure S. in step P8. may be selected from any processing the person skilled in the art would select for a post processing of layers. The post processing is preferably selected from the group consisting of printing onto at least one surface, forming, laser marking or a combination of at least two thereof.

Delaminating layers A., B. and optionally C. may optionally performed in step P9 . . . . Delamination may be established by a process selected from any processing the person skilled in the art would select for a delamination of layers, e.g. through an unwinding and rewinding process, but structure S may be also delaminated inline directly in the blown film extrusion process by adding delamination units (9) into the blown film extrusion line as shown in FIG. 5. If delamination is not performed by hand a conventional delamination machine could be used. If the at least first layer A. is positioned between two further layers B. and/or C. the delamination is preferably performed from both sides of the layered structure S.

Preferably, polymer (A) is selected from the group consisting of is selected from the group consisting of a polycarbonate, a co-polycarbonate, a blend comprising a polycarbonate or a co-polycarbonate, a poly(methyl)methacrylate, a polyester, a co-polyester or a mixture or combination of at least two thereof. Preferably, polymer (A) is different from polymer (C). Preferably, polymer (A) is a polycarbonate or a co-polycarbonate.

In a preferred embodiment of the process, polymer (B) is selected from the group consisting of a cyclo olefin copolymer (COC), a polyolefine, preferably polypropylene, polyethylene types, or a mixture or blend of at least two thereof, but different from polymer (A).

A further aspect of the invention is related to a foil (A), preferably a further layer A. with a thickness in a range of from 3 to 50 μm produced by the process according to the invention.

A further aspect of the invention is the use of the inventive layered structure S. or the layered structure S. produces by the process according to the invention for decreasing birefringence of at least layer A., preferably of the whole layered structure S. to reduce optical defects like chattermarks and or reduce birefringence.

In a preferred embodiment of the use of the layered structure S. the layered structure or the foil is used as part of a battery or as membrane or as part for optical applications.

### FIGURES

Examples of a layered structure S. are shown in

FIG. 1: a schematic illustration of a layered structure S. 100. according to the invention with layer A. 200, and layer B. 300 on both sides of layer A.

FIG. 2: a schematic illustration of a layered structure S. 100 according to the invention with layer A. 200 and layer B. 300 and layer C. 400.

FIG. 3: a schematic illustration of a layered structure S. 100. according to the invention with several layer A. 200. enclosed in several layer B. 300.

FIG. 4: a schematic illustration of a layered structure S. 100. according to the invention with layer A. 200 consisting of multiple layers 201. enclosed in layer B. 300 on both sides.

FIG. 5: A schematic illustration of a process according to the invention

FIG. 6: Greyscale measurement of layer A. of sample 3-A without visible chattermarks

FIG. 7: Greyscale measurement of comparative sample 5 with visible chattermarks

FIG. 8: Greyscale measurement of comparative sample 6 with visible chattermarks

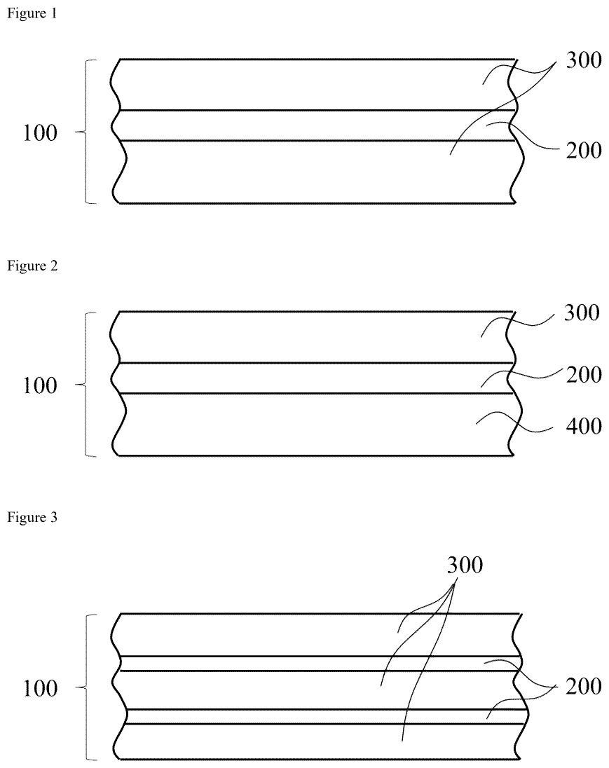

In FIG. 1 a schematic illustration of an inventive layered structure S. 100 is shown, wherein the layered structure S. 100 comprises one first layer A. 200 in the middle of two further layers B. 300. The thickness of the first layer A. 200 is a range of 3 to 50 μm. The thickness of the layered structure S. is in the range of 15 to 250 μm.

In FIG. 2 a schematic illustration of an inventive layered structure S. 100 is shown, wherein the layered structure S. 100 comprises one first layer A. 200 in the middle of a further layer B. 300 and a third layer C. or a further layer B. with a different composition of the second layer B. 400 compared to further layer B. 300. The thickness of the first layer A. 200 is a range of 3 to 50 μm. The thickness of the layered structure S. is in the range of 15 to 250 μm.

In FIG. 3 a schematic illustration of an inventive layered structure S. 100 is shown, wherein the layered structure S. 100 comprises a two first layers A. 200 in the middle of three further layers B. 300. The thickness of the first layer A. 200 is a range of 3 to 50 μm. The thickness of layered structure S. is in the range of 15 to 250 μm.

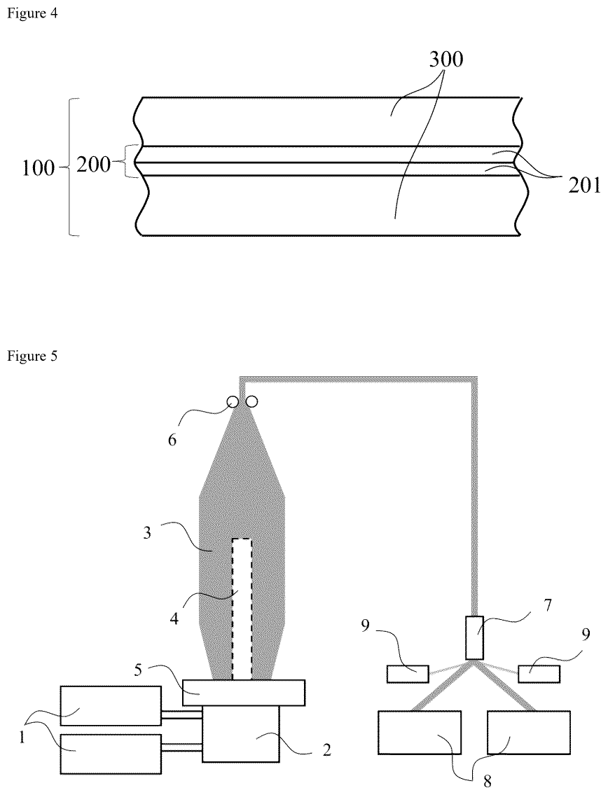

In FIG. 4 a schematic illustration of an inventive layered structure S. 100 is shown, wherein the layered structure S. 100 comprises two sheets 201 of polymer (A) to build a first layer A. 200 in the middle of two further layers B. 300. The thickness of the first layer A. 200 is a range of 3 to 50 μm. The thickness of the layered structure S. is in the range of 15 to 250 μm.

In FIG. 5 a schematic illustration of the inventive process is shown. The used polymer (A), polymer (B), optionally polymer (C) are provided according to steps P1. to P3. of the inventive process, in form of granulates. In step P4. the granulates A., B. and optionally C. are heated in an extruder 1 to a temperature T which is at least 50° C. higher than the softening point or the glass transition temperature of the respective polymer (A), (B) and/or optionally (C) to receive the melts (A), (B) and optionally (C) and delivered to the blown film die 2. In the extrusion step P5. of the inventive process the die 2 brings the melts of polymer (A), (B) and optionally (C) together. The internal bubble cooling 4 pumps air into the extrudate which forms a bubble 3. Outside of the bubble 3 a cooling air flow is generated by the external cooling ring 5. The cooling in step P6. is started after the extrudate has left the die 2 in form of the bubble 3. After or while cooling in step P6. the bubble is hauled-off vertically by a haul-off unit 6 to form a double folded layered structure S. followed by a winding process using at least one winder station 8. Optionally, the double folded layered structure passes a slitting unit 7, which slits the double folded structure. Optionally, the layers of structure S. can be delaminated from each other by delamination units 9 to receive the layered structure S in form of the first layer A. on the one side and the carrier layer(s) B. and C. on the other side.

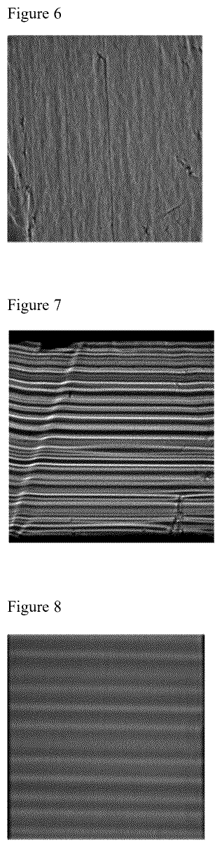

In FIG. 6 a greyscale measurement of layer A. of sample 3-A without visible chattermarks is shown and in FIGS. 7 and 8 greyscale measurements of comparative samples 5 and 6 with visible chattermarks are shown. The FIGS. 6, 7 and 8 are in original in 10×10 cm² size measured with a projection where the film is held in the light beam of a projector with an angle of 45° with respect to the projection wall. The extrusion direction of the samples shown in FIGS. 6, 7 and 8 is in top down direction.

### Experimental Part:

### Production of a Peelable Coextruded Film Comprising Layer A. And Layer B.

The employed apparatus for producing the co-extruded film comprises:
Dryer for pellets
Large scale setup: Five extruders with screws of 65 mm in diameter and a length of 32 D
   Extruder 1 and 2 for melting polymer B and extrusion of melt B to form a layer B
   Extruder 3 for melting polymer A (a polycarbonate or a co-polycarbonate) and extrusion of melt A to form layer A
   Extruder 4 and 5 for melting polymer B and extrusion of melt B to form a layer B
Small scale setup: Three extruders with screw of 50 mm in diameter and a length of 30 D
   Extruder 1 for melting polymer B and extrusion of melt B to form a layer B
   Extruder 2 for melting polymer A (a polycarbonate or co-polycarbonate) and extrusion of melt A to form layer A
   Extruder 3 for melting polymer B and extrusion of melt B to form a layer B
Screen changer after each extruder
Melt pipes as connectors
Large scale setup: 5 layer blown film die head with spiral mandrels with outlet diameter of 600 mm
Small scale setup: 3 layer blown film die head with spiral mandrels with outlet diameter of 200 mm
Cooling ring for outer cooling of the extruder film bubble
Internal bubble cooling with temperature and pressure control
Thickness measurement
Collapsing frame
Reversing haul-off unit
Edge slitting
Winding stations
No embossing nips

Polymers used in the experiments are:
LDPE (low density PE): standard blown film grade type Purell, LyondellBasell Industries BV, Netherlands
   Melt Flow Rate (190° C./2.16 kg): 0.4 g/10 min ISO 1133-1
PC: type Makrolon LED 2245, Covestro Deutschland AG, Germany
   Melt Flow Rate (300° C./1.2 kg): 34 g/10 min ISO 1133-1
co-PC:
   type Durabio D5380, Mitsubishi Chemical Performance Polymers, Japan
   type Durabio D7340IR, Mitsubishi Chemical Performance Polymers, Japan

### Processing of the Samples:

The granulate(s) of the different polymers were conveyed from the dryer into the filling hopper of the extruder via dosing systems. The material was molten and conveyed in the barrel/screw plasticizing system of the extruder. Each melt passed a screen changer with filter elements and enters the die head via individual melt pipes. In the die head, spiral mandrels shape each material in an annular ring and the layers join together before the exit of the die head. The bubble was blown up and cooled by internal bubble cooling and cooling ring. Furthermore, it was hauled-off and collapsed before guided into the slitting and winding stations.

Sample 1 has been produced on a small scale setup with extruders 1 and 3 providing LDPE to form two outer layers B. of the layered structure S. and extruder 2 providing co-Polycarbonate Durabio D7340 IR to form layer A. in the middle. The thicknesses of each layer B. were 15 μm, the thickness of layer A. was 10 μm. Line speed was approx. 13.9 m/min with a BUR of 1.8.

Sample 2 has been produced with the same setup as sample 1, but in order to receive layer thicknesses of 30 μm (layers B.) and 20 μm (layer A.), the line speed was reduced to 7 m/min while BUR remains constant.

Samples 3-A, 3-B and 3-C have been produced on the small scale setup with extruders 1 and 3 providing LDPE for two outer layers B. and extruder 2 providing PC type Makrolon LED 2245 for layer A. of the layered structure S. Layers B. were designed with a 30 μm thickness and layer A. has thickness of 10 μm for sample 3-A, of 15 μm for sample 3-B and of 20 μm for sample 3-C. The layered structure S. was produced at a line speed of 12.7 m/min and a BUR of 1.8.

Sample 4 has been produced on the large scale setup. Extruders 1 and 2 both provide LDPE for one outer layer B. and extruders 4 and 5 provide LDPE for the other layer B. Extruder 3 provided Durabio D5380-R 3 for middle layer A. Thicknesses of outer layer B were 27 μm (15 μm+12 μm) and the thickness of middle layer A was 5 μm. The line speed was 28 m/min with a BUR of 1.42.

Table with process and material data - sample 1:

| | | | | Through- | | | | |
|---|---|---|---|---|---|---|---|---|
| | | Thickness | | put | Melt | Die head | Line | Blow up |
| | | nominal | Density | nominal | temperature | temperature | speed | ratio BUR |
| Sample 1 | Polymer | [μm] | [kg/l] | [kg/h] | [° C.] | [° C.] | [m/min] | [—] |
| Extruder | LDPE | 15 | 0.92 | 12 | 205 | 230 | Approx. | 1.80 |
| 1 | | | | | | | 13.9 | |
| Extruder | Durabio | 10 | 1.36 | 12 | 235 | | | |
| 2 | D7340IR | | | | | | | |
| Extruder | LDPE | 15 | 0.92 | 12 | 205 | | | |
| 3 | | | | | | | | |

Table 2 with process and material data - sample 2:

| | | Thick- | | | | | | |
|---|---|---|---|---|---|---|---|---|
| | | ness | | Throughput | Melt | Die head | Line | Blow up |
| | | nominal | Density | nominal | temperature | temperature | speed | ratio |
| Sample 2: | Polymer | [μm] | [kg/l] | [kg/h] | [° C.] | [° C.] | [m/min] | BUR [—] |
| Extruder 1 | LDPE | 30 | 0.92 | 12 | 205 | 230 | Approx. | 1.80 |
| Extruder 2 | Durabio | 20 | 1.36 | 12 | 235 | | 7 | |
| | D7340IR | | | | | | | |
| Extruder 3 | LDPE | 30 | 0.92 | 12 | 205 | | | |

Table 3 with process and material data - sample 3-A, 3-B, 3-C:

| | | Thick- | | Through- | | | | |
|---|---|---|---|---|---|---|---|---|
| | | ness | | put | Melt | Die head | Line | |
| | | nominal | Density | nominal | temperature | temperature | speed | Blow up |
| Sample 3: | Polymer | [μm] | [kg/l] | [kg/h] | [° C.] | [° C.] | [m/min] | ratio [—] |
| Extruder 1 | LDPE | 30 | 0.92 | 22 | 195 | 230 | Approx. | 1.80 |
| Extruder 2 | Makrolon | 3-A: 10 | 1.19 | 3-A: 9 | 245 | | 12.7 | |
| | LED 2245 | 3-B: 15 | | 3-B: 13.5 | | | | |
| | | 3-C: 20 | | 3-C: 18 | | | | |
| Extruder 3 | LDPE | 30 | 0.92 | 22 | 195 | | | |

Table 4 with process and material data - sample 4:

| | | Thick- | | | | | | |
|---|---|---|---|---|---|---|---|---|
| | | ness | | Throughput | Melt | Die head | Line | Blow up |
| | | nominal | Density | nominal | temperature | temperature | speed | ratio |
| Sample 4: | Polymer | [μm] | [kg/l] | [kg/h] | [° C.] | [° C.] | [m/min] | BUR [—] |
| Extruder 1 | LDPE | 15 | 0.92 | 64 | 210 | 230 | Approx. | 1.42 |
| Extruder 2 | LDPE | 12 | 0.92 | 51 | 210 | | 28 | |
| Extruder 3 | Durabio | 5 | 1.31 | 26.8 | 235 | | | |
| | D5380-R3 | | | | | | | |
| Extruder 4 | LDPE | 12 | 0.92 | 51 | 210 | | | |
| Extruder 5 | LDPE | 15 | 0.92 | 64 | 210 | | | |

### Comparative Sample 5

### Masterbatch for Layer A.:

The production of the masterbatch for the production of layer A. of the co-extruded film was carried out with a conventional twin-screw compounding extruder (ZSK 32) at processing temperatures customary for polycarbonate of 250° C. to 330° C.

A master batch having the following composition was compounded and subsequently granulated:

Master batch 1:100 wt.-% Makrolon® 3108.

### Masterbatch for Layer B.:

The production of the masterbatch for the production of layer B. of the co-extruded film was carried out with a conventional twin-screw compounding extruder (ZSK 32) at processing temperatures customary for COCs of 210° C. to 240° C.

A master batch having the following composition was compounded and subsequently granulated:

Master batch 2:100 wt.-% TOPAS® (Mitsui, Japan).

### Production of Co-Extruded Comparative Film Comprising Layer A. And Layer B. In a Flat Die Extrusion:

The employed apparatus for producing the co-extruded film comprises:
an extruder for melting polymer (A) and extrusion of melt (A) to form layer A. containing at least one polycarbonate with a screw of 60 mm in diameter (D) and a length of 33 D. The screw has a degassing zone;
an extruder for extrusion melting polymer (B) and extrusion of melt (B) to form layer B.
a melt pump;
a crosshead;
a slot die of 450 mm in width;
a three-roller smoothing calendar with horizontal roller orientation, wherein the third roller can swivel by +/−45° relative to the horizontal;
a roller conveyor;
thickness measuring means;
means for double-sided application of protective film;
a haul-off;
a winding station.

The granulate(s) of the respective masterbatch was/were conveyed from the dryer into the filling hopper of the extruder. The material was molten and conveyed in the barrel/screw plasticizing system of the extruder. The melt passed from the slot die onto the smoothing calendar. The final shaping and cooling of the film was carried out on the smoothing calendar (consisting of three rollers).

By utilizing this process the comparative example 5 was processed achieving a layered structure with a layer A out of Master batch 1 (Makrolon® 3108) with a thickness of 20 μm and a 75 μm layer B from Master batch 2 (TOPAS®) in a thickness of 95 μm.

Comparative Sample 6 is a comparative mono layer film made of PC type Makrolon 3108 (Covestro Deutschland AG, Germany) with thickness of 125 μm produced by flat film extrusion. The granules of PC are molten in an extruder and delivered to a flat film extrusion die with coathanger flow channel geometry. After the die, the melt curtain is the formed and cooled in a temperature controlled 3-rollers-calendar. The rollers used for the sample are mirror polished chrome-rollers. The calendar process is followed by a cooling section, masking unit and a haul-off unit including winding.

In Table 5 inventive examples of layer A. are listed together with adhesion forces between different materials for layer A. and layer B. The layer A. could be delaminated from layer B. by hand without deforming one of the layers A. and B. and without any residues on the layers A. and B. of material of the respective other layer or polymer of that other layer.

TABLE 5
Measured values of different materials for layer A. and comparative samples

| | | | Sample | Sample | Sample | | Comparative | Comparative |
|---|---|---|---|---|---|---|---|---|
| Example | Sample 1 | Sample 2 | 3-A | 3-B | 3-C | Sample 4 | sample 5 | sample 6 |
| Measured | 11-13 | | 11-13 | 18-20 | 22-27 | 4 | 19 | 125 |
| thickness | | | | | | | | |
| [μm] * | | | | | | | | |
| Avg. tensile | | | 90 | 60.3 | 88 | 122 | 61 | |
| strength at | | | | | | | | |
| break MD | | | | | | | | |
| [MPa] ** | | | | | | | | |
| Avg. tensile | | | 71 | 56 | 90 | 78 | 57.5 | |
| strength at | | | | | | | | |
| break CD | | | | | | | | |
| [MPa] ** | | | | | | | | |
| Ratio tensile | | | 1.27 | 1.08 | 0.98 | 1.56 | 1.06 | |
| strength at | | | | | | | | |
| break | | | | | | | | |
| MD/CD [—] | | | | | | | | |
| Avg. | | | 107 | 81.9 | 126 | 95 | 107.2 | |
| elongation at | | | | | | | | |
| break MD [%] ** | | | | | | | | |
| Avg. | | | 79 | 31.8 | 132 | 139 | 104.2 | |
| elongation at | | | | | | | | |
| break CD [%] ** | | | | | | | | |
| Ratio | | | 1.35 | 2.58 | 0.95 | 0.683 | 1.03 | |
| elongation at | | | | | | | | |
| break MD/CD | | | | | | | | |
| [—] | | | | | | | | |
| Adhesion | <0.02 | <0.02 | 0.0122 | | 0.0132 | <0.02 | | Not applicable |
| force between | | | | | | | | |
| layer A. and | | | | | | | | |
| layer B. | | | | | | | | |
| [N/cm] *** | | | | | | | | |
| Birefringence | 19.7 | | 11.3 | 7.1 | 2.1 | 12.9 | 8.4 | 30.1 |
| [nm] 4* | | | | | | | | |
| Haze 5* | | | 1.7 | | | 1.1 | | 0.09 |
| Chattermarks | Not | Not | Not | Not | Not | Not | Visible | Visible |
| 6* | visible | visible | visible, | visible | visible | visible | chattermarks, | chattermarks, |
| | | | FIG. 6, | | | | FIG. 7, | FIG. 8, |
| | | | Scale | | | | Scale 10 × 10 | Scale 10 × 10 |
| | | | 10 × 10 cm² | | | | cm² | cm² |
| Transparency | | | 92.6 | | | 94.2 | | 92.4 |
| [%] 7* | | | | | | | | |

* measured according to DIN ISO 4593/0.5N/2.1.2
** measured according to EN ISO 527-3/2/200
*** measured by delamination according to ASTM D903-1998 at a pulling angle of 180°
4* measured by a polarization microscope Ilis Strainmatic M3-007
5* measured with BYK Haze Guard
6* inhouse greyscale analysis
7* measured according to ASTM D1003-13 (BYK Haze Guard)

1. A layered structure S., comprising:
A. at least one first layer A., with a first surface A1 and a second surface A2, comprising at least polymer (A), wherein the first layer A. has a thickness in a range of 3 to 50 μm, and
B. optionally at least one further layer B. comprising at least polymer (B),
wherein the layered structure S. is obtained in a blown film process and
wherein polymer (A) is selected from the group consisting of a polycarbonate, a co-polycarbonate, a blend comprising a polycarbonate and a co-polycarbonate, a poly(methyl)methacrylate, a polyester, a co-polyester and mixture or combinations of at least two thereof.

2. The layered structure S. according to claim 1, wherein the layered structure S. comprises at least one further layer B. and polymer (B), is selected from the group consisting of a cyclo olefin copolymer (COC), a polyolefine and mixtures or blends of at least two thereof.

3. The layered structure S. according to claim 1, wherein the at least one layer A. comprises the polymer (A) in an amount in a range of from 50 to 100 wt.-%; based on the total weight of the at least one layer A.

4. The layered structure S. according to claim 1, wherein layer B. comprises the polymer (B) in an amount in a range of from 50 to 100 wt.-%, based on the total weight of layer B.

5. The layered structure according to claim 1, wherein layer A. of the layered structure S. provides at least one, of the following properties:
S1. in case layer B. is present, an adhesion force between the at least one first layer A. and the at least one further layer B. is in a range of from 0.001 to 0.1 N/cm, measured according to ASTM D903-1998 at a pulling angle of 180°;
S2. a melting temperature of polymer (A)≥150° C.; determined via differential scanning calorimetry (DSC) according to standard DIN EN 61006:2004 at a heating-rate of 20 K/min with definition of T_{g} as the midpoint temperature (tangent method)
S3. a glass-transition temperature Tg of polymer (A)≥40° C.; determined via differential scanning calorimetry (DSC) according to standard DIN EN 61006:2004 at a heating-rate of 20 K/min with definition of T_{g} as the midpoint temperature (tangent method) or a Vicat softening temperature B/50 determined according to ISO 306 (50N; 50°/h) of ≥70° C.;
S4. Melt volume rate (MVR; measured according to DIN ISO1133-1-2012-03; 300° C., 2.16 kg) of ≥3 cm³/10 min; and
S5. solvents in a range of from 0 to 0.5 wt.-%.

6. The layered structure S. according to claim 1, wherein the layered structure S. provides at least one of the following properties:
S6. a thickness in a range of from 15 to 250 μm;
S7. a deviation of the thickness across an area of 20*20 cm² in a range of from 0.1 to 3 μm;
S8. a tensile strength in a range of from 10 to 150 MPa;
S9. an elongation at break in a range of from 20 to 500%, measured according to DIN EN ISO 527-1:2012-06; and
S10. water absorption (ISO 62:2008);) at 23° C. for 24 h) in a range of from 0.01 to 0.5 wt.-% (saturation value).

7. The layered structure S. according to claim 1, wherein layer A. provides at least one of the following properties:
a1. a gloss at 60° angle in a range of 10 to 110, measured according to DIN EN ISO 2813-2015-02;
a2. a surface roughness of at least the first surface A1 in a range of 0.1 to 5.50 μm, measured according to DIN EN ISO 4287:2010-07/DIN EN ISO 4288:1998-04;
a3. a birefringence in a range of from 1 to 100 nm, measured by a polarization microscope;
a4. a transparency in a range of from 5 to 95%, measured according to ASTM D1003-13; and
a5. no optical deviations like chattermarks.

8. The layered structure S. according to claim 1, wherein layer A. provides at least one of the following properties:
a6. a density in a range of from 1 to 1.35 g/l, measured according to ISO 1183-1:2019-09;
a7. a tensile strength in a range of from 10 to 150 MPa, measured according to DIN EN ISO 527-1:2012-06;
a8. an elongation at break in a range of from 20 to 500%, measured according to DIN N ISO 527-1:2012-06;
a9. a thickness in a range of from 3 to 50 μm; and
a10. a deviation of the thickness in a range of from 0.1 to 3 μm.

9. The layered structure S. according to claim 1, wherein the layered structure S. further comprises at least one layer C., comprising a polymer (C).

10. The layered structure S. according to claim 1, wherein the at least first layer A. is positioned between two further layers B., preferably in form of layer B.-(layer A.-layer B.); with i=1 to 5.

11. A process for the manufacture of a layered structure S., wherein the layered structure S. comprises at least one first layer A. having a thickness in a range of from 3 to 50 μm, the process comprising at least the following steps
P2. providing a granulate A. comprising a polymer (A),
P3. providing a granulate B. comprising a polymer (B),
P4. optionally, providing a granulate C. comprising a polymer (C),
P5. heating granulate A. and granulate B. and/or optionally granulate C. to a temperature T which is at least 50° C., higher than the softening point or the glass transition temperature of the respective polymer (A), (B) and/or optionally (C) to receive the melts (A), (B) and optionally (C);
P6. extruding the melt of at least melt (A) and melt (B) and/or optionally melt (C) in a blown film extrusion line to receive an extrudate of at least one layer A. from melt (A) with a thickness in a range of from 3 to 50 μm and a layer B. from melt (B) and/or optionally at least one layer C. from melt (C) to receive the layered structure S.;
P7. cooling down the layered structure S. to a temperature in a range of from 10 to 50° C.;
P8. optionally rolling the layered structure S. onto a roll;
P9. optionally post processing the layered structure S., wherein the post processing is selected from the group consisting of printing onto at least one surface, forming, laser marking, and a combination of at least two thereof;
P10. optionally delaminating layers A., B. or C. through an unwinding and rewinding process, or preferably inline delamination process,
wherein polymer (A) is selected from the group consisting of a polycarbonate, a co-polycarbonate, a blend comprising a polycarbonate and a co-polycarbonate, a poly(methyl)methacrylate, a polyester, a co-polyester, and a mixture of at least two thereof.

12. The process according to claim 11, wherein polymer (B) is selected from the group consisting of a cyclo olefin copolymer (COC), polypropylene, polyethylene types and a mixture or blend of at least two thereof, but different from polymer (A).

13. A foil, especially a first layer A., with a thickness in a range of from 3 to 50 μm produced by the process according to claim 11.

14-15. (canceled)
